(19) United States
(12) Patent Application Publication
(10) Pub. No.: US 2006/0242895 A1
(43) Pub. Date: Nov. 2, 2006

(54) Clone kit

(76) Inventor: William Winkler, Oakland, CA (US)

Correspondence Address: DLA PIPER RUDNICK GRAY CARY US LLP, 153 TOWNSEND STREET, SUITE 800, SAN FRANCISCO, CA, 94107-1907, US

(21) Appl. No.: 11/118,699

(22) Filed: Apr. 29, 2005

(51) Int. Cl. A01G 9/16

(52) U.S. Cl. 47/17

(57) ABSTRACT

A durable plastic gardening device made for the amateur and professional gardener for cloning (asexually propagating) plants. Made from clear polypropylene the grow chamber and light hood fold together and assemble using plastic fasteners.

### BACKGROUND

The following references are hereby incorporated by reference for all purposes:

U.S. Pat. Nos. 2,803,923, 4,065,876, 4,316,347, and 4,685,246;

U.S. published apps nos. 2001/0047617 and 2004/0103583; and

British patent no. GB 557269.

Often gardeners want to reproduce a favorite plant because they are pleased with the color, yield or other qualities of a plant. If an exact genetic duplicate is desired, the gardener clones his favorite plant. By cloning, the resulting plant shares the same genetics of the plant that the cutting was taken from.

The cloning process is as follows: The new plant is created by taking a small branch from the favored (mother) plant. The branch that is taken from the mother plant is treated in a way that allows the said branch (cutting) to grow roots and prosper as a new plant.

Making the transition from a branch of a living plant to a new individual living plant can be tenuous, and an artificial environment that is favorable to this transition must be created. The clone kit provides this favored environment. There must be the correct warmth, humidity, light, and water or nourishment to make this happen. Not only is it important to have the correct environment, this environment must be adjusted as the plant branch transforms itself into a new plant. Without a higher then ambient humidity and proper light, the cutting will not develop a root system that all plants require. The professional gardener can control this favored environment by using a greenhouse or cold frame but often this is to large scale for the home gardener, classroom, or agricultural experiment.

The smaller grower needs a small unit that will provide all that's needed for cloning. The clone kit provides warmth, moisture and light. All three are required in cloning and these three factors can be controlled and adjusted by opening vents or disconnecting the light, or spraying water into the grow chamber as required. These factors are adjusted as the plant branch or cutting transforms itself from a cutting to a new plant. This preferred embodiment provides the three important growing factors required for the cloning process (light, warmth, moisture). It also provides a way of modifying these factors as needed during the cloning process and allows this growing technique to be done indoors where direct sunlight is not available.

After the cutting has transformed itself into a new plant -the said plant is taken out of the clone kit and replanted into a larger pot or outside to continue its natural life. If the gardener uses rockwool or similar substrate the new plant can be placed into a hydroponic system to continue its natural life. In the preferred embodiment, the clone chamber and the light hood are held together using 2 part plastic fasteners, but metal fasteners could be used, and tabs such as the type used for common cardboard box construction cut into the material could be used. This would eliminate the need for two part fasteners but would made the structure harder to assemble and disassemble.

The “grow chamber” #300 with or with out the light and light hood #200 can be used as a cloche outdoors to protect young plants from frost. If this use is required the light hood can be removed and a handle is attached to the top of the “grow chamber” by cutting out the rectangular score marks #301 and affixing a handle.

Referencing British patent No. 557269 Crawford discloses a garden cloche or portable greenhouse comprising a central ridge to receive the upper edges of the panes of glass on each side thereof, channels to receive the lower edges of the panes of glass” “The ridge is provided with a handle by which the cloche or portable greenhouse as a complete unit can be raised and transported.

The aforementioned-patented portable greenhouse has a number of drawbacks. For example the triangular shape is not efficient for total inside volume. The shape restricts the height of the plants that the portable greenhouse is covering by requiring only short plants on the sides but allowing large plants in the middle. The use of metal for the frame and glass for the glazing makes for a heavy and fragile unit. Due to the lack of its own light, this unit is restricted to outdoor use.

Referencing U.S. Pat. No. 4,316,347 Smith discloses a portable solar garden which is large enough to accommodate an individual for gardening operations. Box like shelves are also included for broadening the possible operations which can be performed within the portable solar garden.

The aforementioned-patented growing device, although small by greenhouse standards, it's still much larger then required for cloning plants on a smaller scale. The portable solar garden is for outdoor use requiring sunlight.

Referencing U.S.2001/0047617, Blossom discloses, a hydroponic garden apparatus comprising a frame; a reservoir; members for holding plants and further including a light assembly supported by the one or more cross support members.

In the above device, the nourishment is delivered hydroponicly. This devise does not have an enclosed space; moisture cannot be controlled, which is used in the cloning process. The preferred embodiment is intended for growing mature plants.

### BRIEF DESCRIPTION OF DRAWINGS

FIG. 1A is an over all figure of the clone kit and heavy duty tray.

FIGS. 1B-1D are an exploded view of the clone kit showing its major parts.

FIG. 2A illustrates the light hood assembled with the handle in place.

FIG. 2B illustrates the light hood assembled and the light in place the side access panel is open.

FIG. 3 illustrates the clone chamber in its assembled state.

FIG. 4 illustrates the heavy duty tray.

FIG. 5 illustrates the die line for the light hood.

FIG. 6 illustrates the die line for the clone chamber.

### DESCRIPTION OF A PREFERRED EMBODIMENT

Through out this summary the terms long sides and short sides will be used to simplify specific observations and references as the preferred embodiment is of a symmetrical shape, be it the light hood grow chamber or tray.

This preferred embodiment is of the type of design and construction that allows for manufacturing using standard manufacturing techniques-steel rule die cutting and plastic vacuum forming. Assembly by the user requires no sophisticated tools, as the fasteners needed are plastic requiring only fingers to fasten.

The preferred embodiment works with the limitations of standard plastic sheet stock sizes, reducing waste in the manufacturing process.

The preferred embodiment provides a system and environment that favors the asexual propagation (cloning) of plants.

The preferred embodiment provides a device that can be easily broken down into its primary plastic types for easy recycling.

The preferred embodiment includes a light chamber with handle fastened to a grow chamber, making removal of both chambers easy. The light, enclosed in its own chamber is removed or insulated from moisture and water spraying. This is advantageous in the growing process, and also lowering the chance of electrical shock or failure.

The Clone Kit permits successful cloning, providing an ideal environment for cloning plants—providing light, warmth and humidity and humidity adjustment. The Clone Kit may also be used for sprouting seeds.

In the preferred embodiment, the clone kit has an adjustable humidity chamber called the “grow chamber” and a florescent grow light in its own chamber called the “light chamber” that provides light as well as heat. The “light chamber/grow chamber” unit fits into a standard garden flat tray that fits inside a heavy-duty tray, to complete the unit. Inside the grow chamber the cuttings are placed one each into small garden pots containing a soil mixture. The bottom tray holds the soil filled plant cups or soil-less substrate such as rockwool cubes that hold the plant cuttings. The preferred method of servicing the cuttings is done by lifting the unit with the handle on top of the light chamber, away from the tray.

In an alternative embodiment, servicing the plants can be from a short side of the grow chamber. The fasteners on the short side can be removed and the short side can be flipped up to allow access.

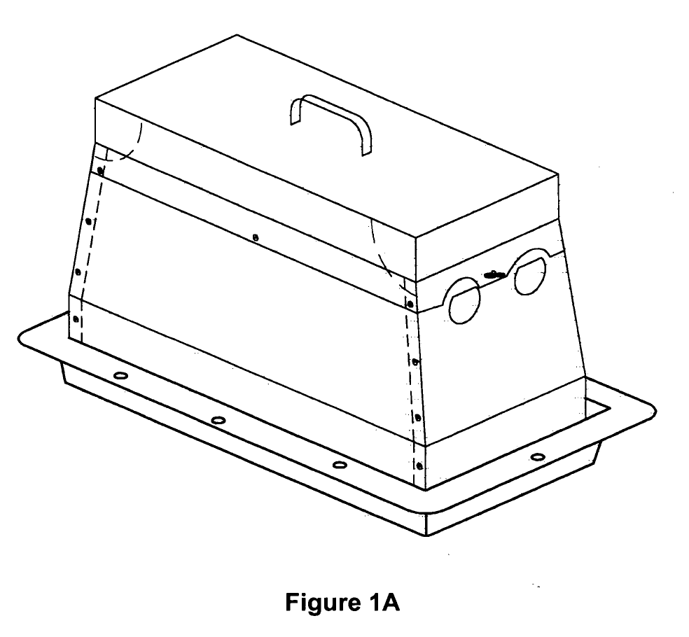

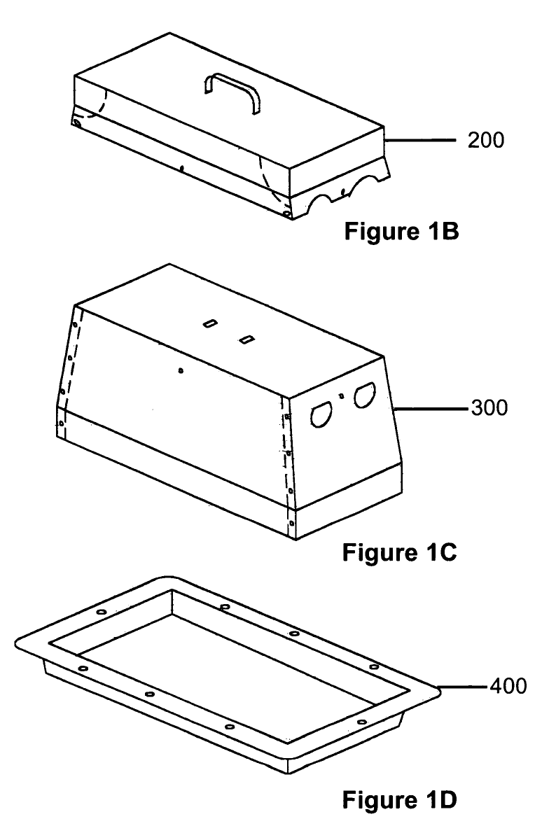

Referring to FIG. 1, this figure shows the fully assembled gardening device. The light hood #200 is coupled to the grow chamber #300. This coupled structure can be lifted out of the bottom tray using the handle.

Referring to FIG. 1B, this figure is the exploded view showing the required elements of the preferred embodiment. The top illustration shows the light hood #200 folded into a rectangular shape. The center illustration shows the grow chamber folded into shape and held together with fasteners. The bottom illustration shows the tray.

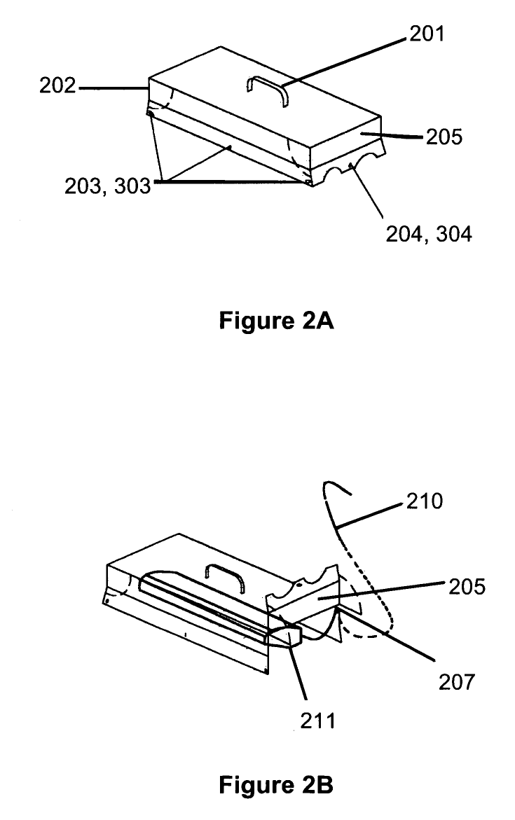

Referring to FIG. 2A, this figure shows is the light hood in its assembled state. The handle #201 is a snap on polypropylene with the two handle flanges coming thru the handle slots #206. the holes on the long sides #203 of the light chamber line up with the holes on the long sides of the grow chamber #303. The holes on the short sides #204 of the light chamber line up with the holes on the short sides of the grow chamber #304. holding the light access flap #205 closed with a plastic wing nut.

Referring to FIG. 2B, this figure shows the light hood folded into shape and showing the florescent light #211 in place. The light access flap on both short sides #205 lifts up for access to the light and is held down and in place with a wing nut through hole #204 and hole #304. the lights electric cord #210 is run thru the light cord slot #207 and to a timer or directly to a power source.

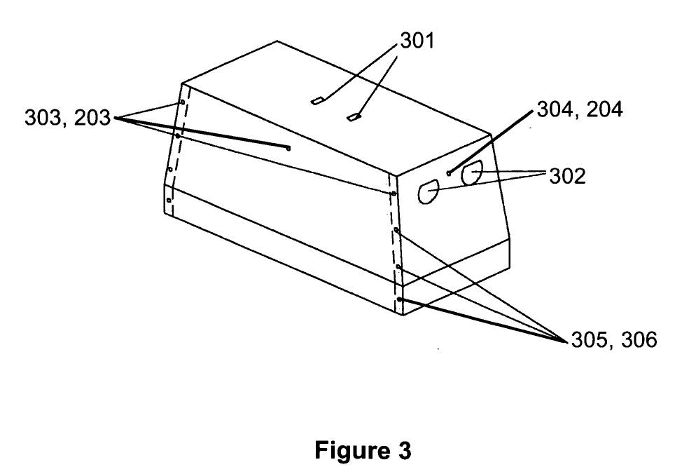

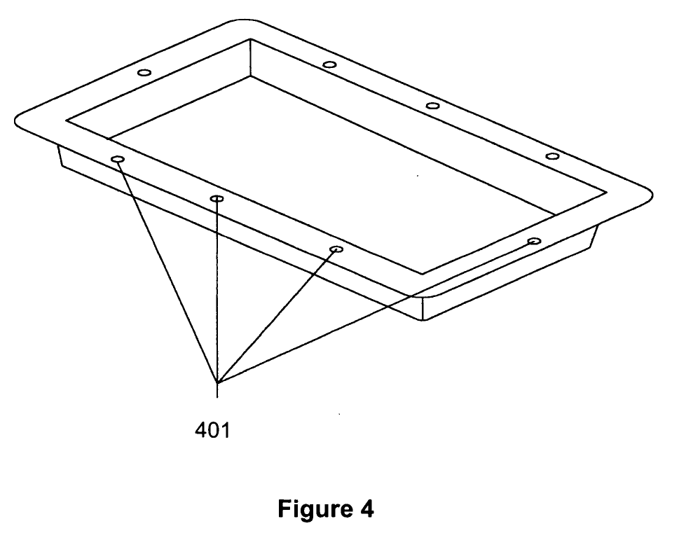

Referring to FIG. 3, the clone chamber/grow chamber #300 is die cut from0.45 polypropylene. All holes and score lines are made in one step leaving a flat sheet after the die cutting operation. All the score lines should be folded over before assembly. The clone chamber is folded together and held together with plastic friction fasteners. The male part of the fastener is inserted from the outside of the structure through holes #305 in the long sides and then through the holes in the folded over short side #306. The female part of the fastener is now put on the fastener shaft from the inside of the grow chamber. When assembling this part, only the bottom three holes on all four edges are used—the top 6 holes are fastened only when the light hood is fastened in place.

There are two scored rectangles #301 on the top of the clone chamber that can be cut through by hand if a handle is required on top of the clone chamber. There are two vent holes #302 on each short side (total 4 holes) these holes can be opened and closed as required to regulate the humidity. In the beginning of the cloning process the vents are closed but as the cloning process progresses the vent holes are opened to reduce the amount of humidity on the inside.

The grow chamber can be used in the cloning process by itself without the light hood. In a less preferred embodiment, a light is set on top of the grow chamber or hung inside the grow chamber.

Referring to FIG. 4, starting at the bottom of the clone kit is the #400 heavy duty tray. The tray is vacuum formed from 3/16 abs plastic. This provides a rigid base for the rest of the clone kit. The heavy-duty tray allows a standard 10×17 inch garden flat to fit inside. These garden flats are formed from thin styrene. Around the parameter of the heavy-duty tray are edge holes #401 that allow a cord to be strung through the holes and around the top of the clone kit providing a system for carrying the complete clone kit by the handle from location to location. When the clone kit is in use the flower pots or soilless rockwool weigh more then can be supported by the styrene tray liner alone. The clone kit can be used with of with out the liner tray.

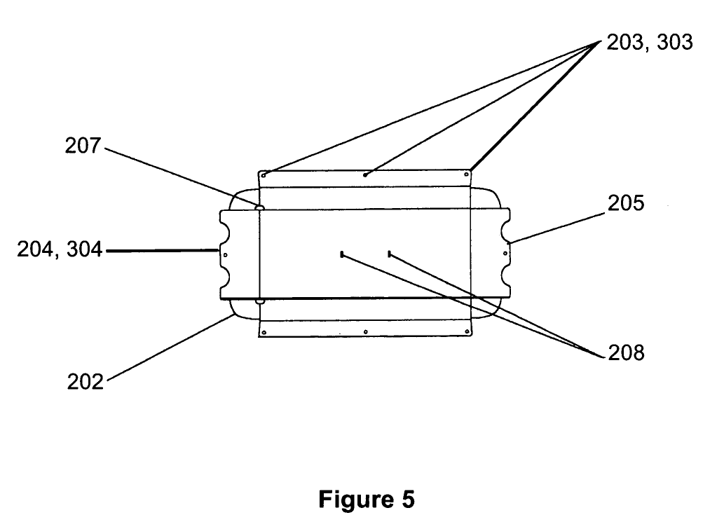

Referring to FIG. 5, this figure shows the light hood in its prefolded flat state. Designed so as 2 parts can be cut from one standard sheet size using the same material as the clone chamber, all of the holes as well as the handle holes #206 and the holes for the electrical cord exit #207 are cut in the die cutting process. This part is folded onto a rectangular cube that attaches to the top of the clone chamber at points #303 on the long sides with side access flaps #205 that allow a light to be inserted and sealed inside the light access flap being held in place with a wing nut fastener at holes #204.

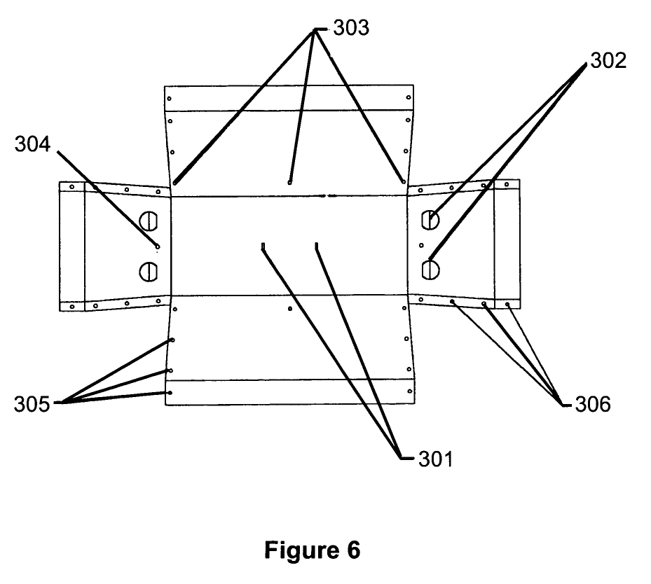

Referring to FIG. 6, this figure shows the clone chamber in its pre folded state. This art is die cut in a conventional die cutting method with a steel rule die, that cuts one part at a time making the thru cut as well as the score in one operation. The material is folded at the score when assembled. The material used is clear 0.045 polypropylene although other materials such as polyethylene or vinyl could be used. This is a standard heavy-duty thickness for polypropylene, although a thinner stock could be used to lower cost although structural strength would be reduced. This part is designed to take advantage of standard sheet sizes and reducing waste material. Using clear plastic stock allows the gardener to look inside with out having to lift the clone kit. The 4 round vent holes #302 cut into the short sides are cut through the plastic sheet except the top of the circle, which is scored to allow the holes to be opened and closed as needed. When assembled the tab edges on the short sides will fit under the long sides edges and reside on the inside of the “grow chamber”.

While an exemplary figure and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention.

I claim:

1. A growth chamber for growing asexually propagating plants, comprising:
(a) a durable housing formed from a single plastic sheet;
(b) a tray coupled with the housing to provide enclosed and sufficiently controllable space for growing the plants and permitting the chamber to be portable; and
(c) an artificial light chamber coupled to the housing for irradiating the space with artificial light through the plastic housing material such that heat and the artificial light are transmittable into the enclosed plant growing space, while the plant growing environment is shielded from interaction with the artificial light chamber environment.

2. A growth chamber as in claim 1, further comprising a handle for further facilitating portability of the chamber.

3. A growth chamber as in claim 1, wherein the housing has defined therein one or more adjustable vent holes for controlling the plant growing environment.

4. A growth chamber as in claim 1, wherein the tray comprises a heavy-duty tray having top side inner dimensions similar to bottom-side outer dimensions of said housing so that the housing just fits into the tray forming a static seal.

5. A growth chamber as in claim 1, wherein the plastic housing material provides a moisture barrier between the light chamber and the plant growing space.

6. A growth chamber as in claim 1, wherein the tray has a bottom side dimension and the housing or light chamber, or both, have a top side dimension such that multiple chambers may be stacked one on top of the other.
